(19) United States
(12) Patent Application Publication
(10) Pub. No.: US 2007/0127232 A1
(43) Pub. Date: Jun. 7, 2007

(54) Tattletale cap

(76) Inventor: Larry Wayne Maier SR., Columbus, OH (US)

Correspondence Address: Larry Wayne Maier Sr., 204 S. SOUDER AVE. APT. E, COLUMBUS, OH, 43222, US

(21) Appl. No.: 11/242,416

(22) Filed: Dec. 6, 2005

(51) Int. Cl. F21V 21/08

(52) U.S. Cl. 362/103

(57) ABSTRACT

A baseball cap or other headwear with a programmable light emitting diode sign affixed to cap. The programmable light emitting diode sign can be made to accommodate the headwear. The light emitting diode can also be programmed to scroll messages programmed by the owner of the headwear.

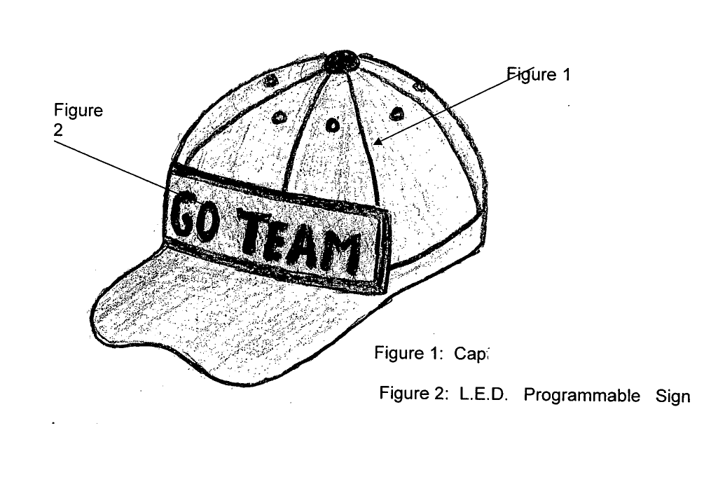

A scrolling programmable light emitting diode sign attached to a ball cap, hat, or other headwear.

The light emitting diode sign could be programmed by user, by means of a compact keyboard attached by wire to the light emitting diode sign or by computer.

1. The light emitting diode sign would be approximately 2 inches by 5 inches and attached to hat by means of snaps, zipper pouch, Velcro et cetera. The letters would be large enough to read from a short distance.
